(19) United States
(12) Patent Application Publication
(10) Pub. No.: US 2025/0103411 A1
(43) Pub. Date: Mar. 27, 2025

(54) MACHINE LEARNING FRAMEWORK FOR PREDICTING AND AVOIDING APPLICATION FAILURES

(71) Applicant: AMERICAN EXPRESS TRAVEL RELATED SERVICES COMPANY, INC., New York, NY (US)

(72) Inventors: Radhakrishnan P. BALAN, Phoenix, AZ (US); Sairam PANDRAVADA, Phoenix, AZ (US); Manmeet Singh DUGGAL, Phoenix, AZ (US); Julian Elsington CHAMBERS, Phoenix, AZ (US); Ritesh MODI, Phoenix, AZ (US); Rana Alexander RAJAMEDISON, Phoenix, AZ (US); Padukere Tejas UPADHYA, Karnataka (IN); Shashank SRIVASTAVA, Uttar Pradesh (IN); Avish JAIN, Madhya Pradesh (IN); Man Chon U, Sunrise, FL (US)

(73) Assignee: AMERICAN EXPRESS TRAVEL RELATED SERVICES COMPANY, INC., New York, NY (US)

(21) Appl. No.: 18/473,708

(22) Filed: Sep. 25, 2023

(51) Int. Cl. G06F 11/00; G06F 11/30; G06F 11/34

(52) U.S. Cl. CPC G06F 11/008; G06F 11/302; G06F 11/34

(57) ABSTRACT

Disclosed herein are system, method, and computer program product embodiments for providing application resiliency using a machine learning model trained to detect potential failures based on computational transaction metrics. A resiliency system may monitor metrics related to an application executing on an enterprise data system. The resiliency system may apply these metrics to a machine learning model trained to identify a potential application failure based on application usage trends. In response to detecting a potential failure of the application, the resiliency system may instruct the application to execute one or more resiliency actions. These may include one or more circuit breaker, rate limiter, time limiter, and/or bulkhead actions. The resiliency actions may aid the application in avoiding failure states. The resiliency actions may also be modified based on feedback metrics to aid the application in quickly restoring service once the failure state has been avoided.

### BACKGROUND

### Field

This field is generally related to providing application resiliency using a machine learning model trained to detect potential failures based on computational transaction metrics.

### Related Art

As enterprise computing systems and technologies continue to evolve, businesses face the issue of scalability and service. For example, enterprise computing platforms may receive numerous transaction requests from various client devices. These client devices may wish to access applications managed or provided by the enterprise computing platforms. A flood of such requests, however, may result in application service degradation, delays, service outages, and/or application failures. Such issues may frustrate users and/or lead to unexpected application downtime. For example, site unavailability due a distressed application or system may lead to a poor customer experience. This may also lead to cascading application failures.

### BRIEF SUMMARY

Disclosed herein are system, apparatus, device, method and/or computer program product embodiments, and/or combinations and sub-combinations thereof, for providing application resiliency using a machine learning model trained to detect potential failures based on computational transaction metrics. Application resiliency may refer to the ability to anticipate and/or address potential issues with an application. For example, resiliency actions may be taken to avoid and/or reduce downtime, cascading failures, and/or application outages.

Monitoring computational transaction metrics using a machine learning model and/or determining a corrective action may aid in alleviating distressed computing systems. This may be used in an enterprise computing platform where client devices may be accessing applications. Such applications may include microservice applications accessed via mobile applications and/or web applications on a client device. For example, these client applications may use a web API to access microservice applications provided by the enterprise computing platform. A large number or flood of such requests, however, may lead to system or application distress, outages, and/or API failures.

To avoid and/or to quickly remediate such issues, this description provides a machine learning framework for predicting and/or avoiding application failures. This may provide an intelligent resiliency framework. In some embodiments, a resiliency system may predict potential application failures using a machine learning model. The resiliency system may also proactively activate one or more response mechanisms to avoid and/or remediate service degradation issues. The machine learning model may be trained based on infrastructure utilization trends, application traffic trends, error trends, and/or other computing system metrics to predict potential failures, resource usage spikes, and/or performance degradations. The machine learning model may then be used during the monitoring of such computational transaction metrics for a particular application. When monitoring these computational transaction metrics, the resiliency system may detect a potential application failure. For example, the machine learning model may detect trending parameters that indicate the imminent onset of a potential large amount of transaction requests in a short amount of time. Such conditions may lead to application outages, slow responses to transaction requests, and/or potential application failure.

In response to a detected potential application failure, the resiliency system may execute one or more response actions. The response action may include transmitting a command to the affected application, which may limit transaction access and/or transaction executions. The response actions include a circuit breaker action, a rate limiter action, a time limiter action, and/or a bulkhead action. The circuit breaker action may open or close a logic circuit to divert transactions from a failing or degraded system. The rate limiter action may limit the traffic volume to a stressed system. The time limiter action may set timeout values for operations within a stressed system. The bulkhead action may limit the number of concurrent executions in a stressed system.

One or more of these actions may be used to avoid and/or preemptively address potential application failures. Avoiding such issues may avoid and/or quickly remediate service degradation for applications executing on an enterprise computing system. For example, this may avoid application outages. Providing application resiliency and/or corrective actions to avoid service degradation may conserve computational resources and/or also avoid costly or wasteful computational resources that would be used to re-initialize failed applications. For example, this may allow for the avoidance of restarting an application or a virtual machine. Such restarts could be on the order of hours, which may result in additional degradation of service.

In some embodiments, even if an application and/or system experiences downtime, the resiliency system may reduce this amount of downtime and/or provide mechanisms to alleviate distressed systems. For example, availability of the application may also be maintained during impact times. Similarly, the resiliency system may also detect and/or avoid bot attacks or Distributed Denial-of-Service (DDOS) attacks.

### BRIEF DESCRIPTION OF THE DRAWINGS

The accompanying drawings are incorporated herein and form a part of the specification.

FIG. 1A depicts a block diagram of an application resiliency environment, according to some embodiments.

FIG. 1B depicts a block diagram of an application resiliency environment with a resiliency system external to an enterprise data system, according to some embodiments.

FIG. 2 depicts a flowchart illustrating a method for detecting a potential application failure and preemptively avoiding such a failure, according to some embodiments.

FIG. 3 depicts a flowchart illustrating a method for activating a resiliency mechanism, according to some embodiments.

FIG. 4 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing application resiliency using a machine learning model trained to detect potential failures based on one or more computational transaction metrics. Upon detecting a potential application failure, a resiliency system may execute a resiliency actions to avoid application downtime and/or application outages.

Various embodiments of these features will now be discussed with respect to the corresponding figures.

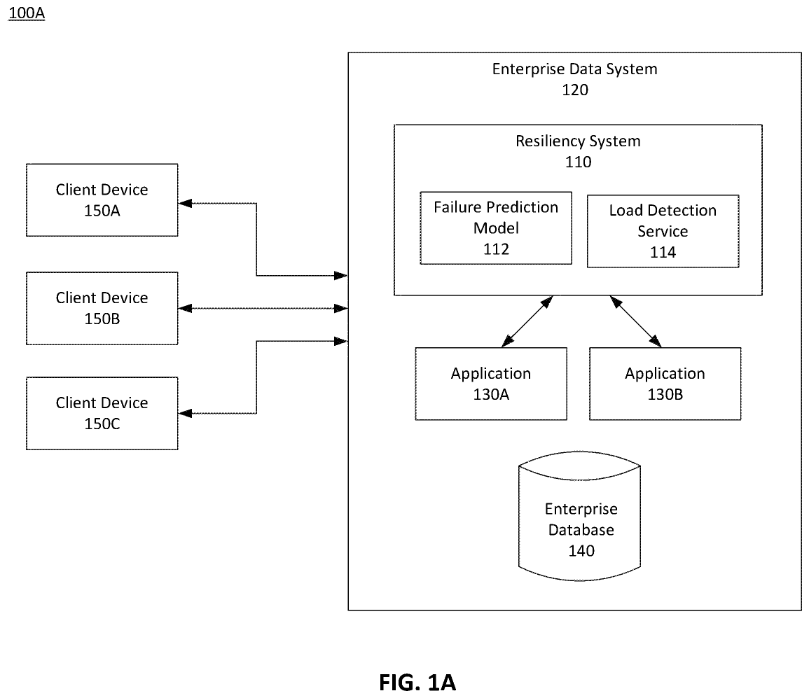

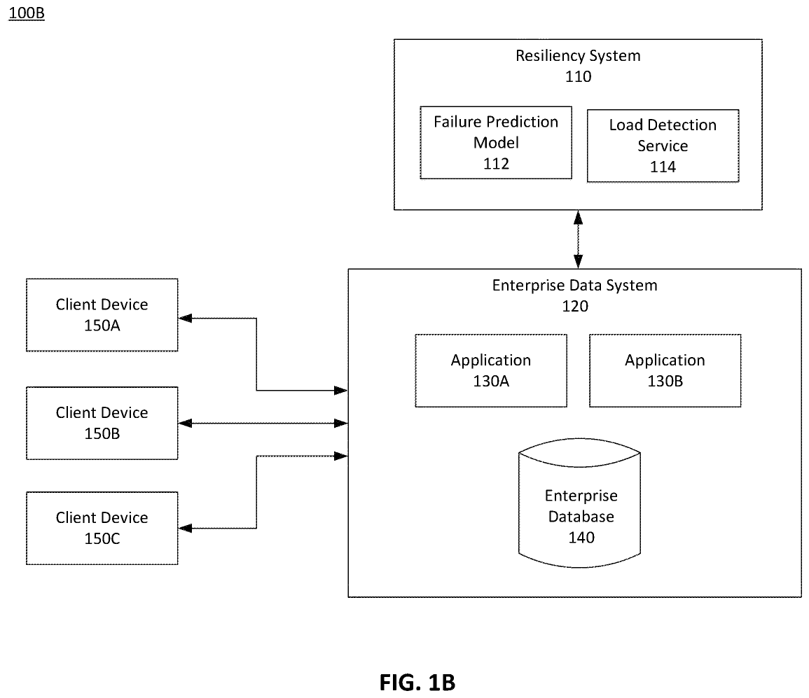

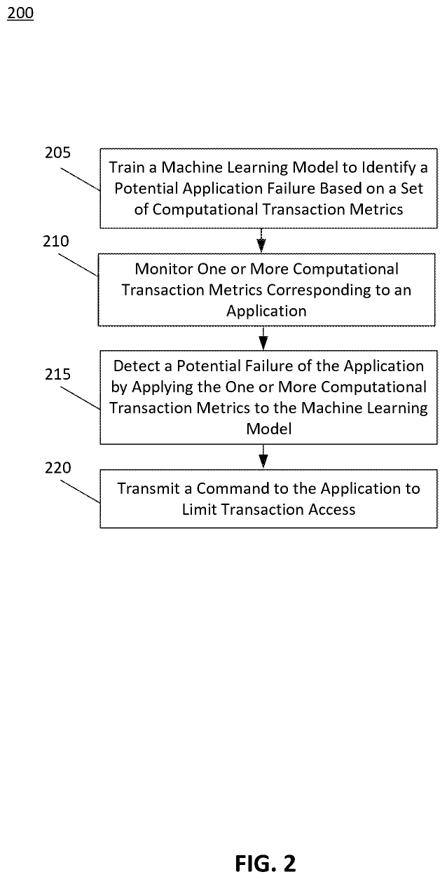

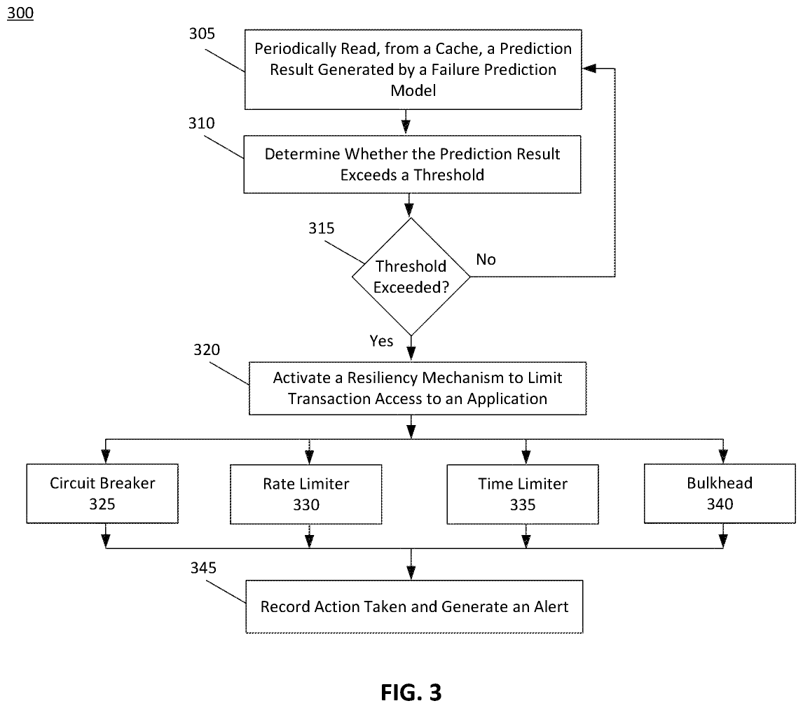

FIG. 1A depicts a block diagram of an application resiliency environment 100A, according to some embodiments. Application resiliency environment 100A includes resiliency system 110, enterprise data system 120, applications 130, enterprise database 140, and/or client devices 150. Resiliency system 110 further includes failure prediction model 112 and/or load detection service 114. As further described below, resiliency system 110 may execute the methods and/or programming described with reference to FIG. 2 and/or FIG. 3. Resiliency system 110 may utilize these methods separately and/or in combination to detect potential failures that may occur in an application 130 and/or to activate a resiliency mechanism to avoid and/or to remediate service degradation.

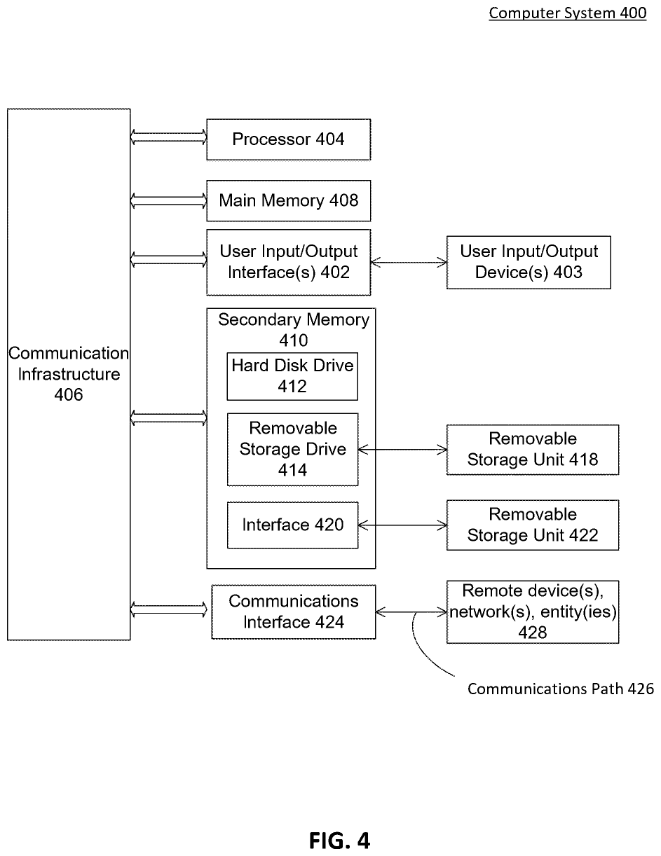

Resiliency system 110 may be a computer system such as computer system 400 described with reference to FIG. 4. For example, resiliency system 110 may be implemented using one or more servers and/or databases. Resiliency system 110 may further include one or more operating systems. In some embodiments, resiliency system 110 may be implemented on an enterprise data system 120. Enterprise data system 120 may be an enterprise computing platform. Enterprise data system 120 may also be implemented using one or more servers and/or databases and/or computer system 400 described with reference to FIG. 4. Enterprise data system 120 may host and/or manage access to one or more applications 130. Client devices 150 may wish to access these applications 130. Client device 150 may be a desktop workstation, laptop or notebook computer, netbook, tablet, smart phone, and/or other computing device. Client devices 150 may use a mobile application and/or a web application to access enterprise data system 120 and/or applications 130. For example, applications 130 may be accessed via API functionality.

Applications 130 may be microservice applications. For example, an application 130 may correspond to user transaction account functionality. Such an application 130 may allow a user to check a corresponding transaction account balance and/or view recent transactions. The data associated with each user may be stored in enterprise database 140. Another application 130 may be a rewards platform to manage different loyalty rewards. Yet another application 130 may be an interactive help platform providing assistance with various account issues. For example, the help platform may aid in providing forgotten login credentials, addressing disputed transactions, and/or receiving client feedback. Some applications 130 may also depend on interactions and/or data from other applications. For example, application 130B may be dependent on data generated by and/or functions performed by application 130A. In this case, if application 130A experiences service degradation, this may also negatively impact application 130B. For example, there may be undesirable cascading failures. Resiliency system 110 may detect and/or mitigate such issues via one or more resiliency mechanisms.

Resiliency system 110 may include failure prediction model 112 and/or load detection service 114. Load detection service 114 may track one or more computational transaction metrics corresponding to one or more applications 130. These computational transaction metrics may relate to the transactions and/or functionality being executed by application 130, a hardware metric corresponding to application 130, a hardware metric corresponding to enterprise data system 120, system metrics, and/or other performance indicators corresponding to application 130. For example, the computational transaction metrics may include application traffic rates, an application 130 traffic trend, a rate of transactions per second, an application 130 response time, timeout rate, number of failed transactions, number of ignored transactions, error trends, resource spikes, a rate of infrastructure hardware usage, CPU usage information, memory usage information, heat or temperature information, a number of active threats, virtual machine configuration information, virtual machine health information, thread pooling, database connectivity health, system permissions, and/or other performance indicators corresponding to an application 130. Load detection service 114 may monitor this data using logs, real-time system monitoring systems, real-time application monitoring systems, and/or data sources. This may include real-time monitoring of transactions occurring at application 130 and/or on a cloud or virtual machine platform executing application 130. In some embodiments, load detection service 114 may use a Splunk® and/or a Dynatrace® system for monitoring system and/or application 130 metrics.

Using the one or more computational transaction metrics, resiliency system 110 may predict whether a potential failure may occur at application 130. Resiliency system 110 may use failure prediction model 112 to perform this prediction. Failure prediction model 112 may be a machine learning model and/or may implement artificial intelligence. In some embodiments, failure prediction model 112 may use a time series model. For example, failure prediction model 112 may be a statistical model configured to forecast data determined from time series data. Failure prediction model 112 may learn or identify trends and/or predict potential failure states. In some embodiments, failure prediction model 112 may implement an autoregressive integrated moving average (ARIMA) model, a linear regression model, decision trees, a neural network, a recurrent neural network (RNN), XGBoost, AdaBoost, and/or other algorithms to predict potential failure states. For example, these models may identify and/or forecast upcoming points in a time series. The forecasted and/or predicted data points may be used by resiliency system 110 to determine whether one or more computational transaction metrics may reach a value indicating a potential failure state.

In some embodiments, failure prediction model 112 may generate a confidence score. This confidence score may correspond to a predicted accuracy of a predicted or forecasted computational transaction metric. Failure prediction model 112 may also undergo re-training and/or use feedback data for re-training to increase the confidence score and/or to more accurately predict potential failure states based on one or more computational transaction metrics.

The computational transaction metrics identified by load detection service 114 may vary over time. Failure prediction model 112 may consider the variations over time as well to detect potential patterns that may potentially cause application 130 to enter a failure state. By detecting these trends, failure prediction model 112 may determine a corrective action to avoid and/or minimize downtime or failure of application 130. Failure prediction model 11 may determine whether application 130 is capable of supporting upstream traffic with or without additional resiliency modifications.

In some embodiments, failure prediction model 112 may generate a prediction that corresponds to a computational transaction metric. For example, failure prediction model 112 may generate a predicted transaction response time, success rate, CPU usage rate, and/or other metric based on time series data. These predictions may be categorized and/or a resiliency action corresponding to the category may be executed. The categories may be different thresholds and/or degrees on a spectrum. For example, a particular predicted CPU usage rate may be categorized into green, yellow, or red categories. A low CPU usage such as a percentage below 60% may be categorized as green. This may indicate that no action is needed. A medium CPU usage, such as a percentage between 60% and 80%, may be categorized as yellow. This may indicate that some corrective action is needed. For example, resiliency system 110 may indicate that transaction rate limiting should be deployed at an application 130. A high CPU usage, such as a percentage above 80%, may be categorized as red. This may indicate that immediate corrective action is needed. For example, resiliency system 110 may indicate that a circuit breaker action should be deployed at application 130. This may cease execution of transactions to divert transaction requests. In this manner, resiliency system 110 may detect potential failures and/or perform corrective actions.

Upon detecting a potential failure and/or service degradation, resiliency system 110 may activate a resiliency mechanism to lessen and/or avoid the impact of the application issue. For example, this may lessen user impact and/or cascading failures. Resiliency system 110 may transmit a command to the application 130 that may be predicted to experience the service degradation. In some embodiments, this may be a prediction notification. For example, resiliency system 110 may deliver a message to application 130 via a distributed event store, cache, or platform. In some embodiments, resiliency system 110 may use a message broker and/or a middleware system to pass the message. This may be a high-throughput and/or low-latency platform that may manage real-time data feeds. This message delivery may also be performed even if application 130 is experiencing service degradation. In some embodiments, the notification may be stored and/or pushed to the application 130 via a cache storage. This provide faster access by application 130 to the information. In some embodiments, this notification may be presented in a periodic manner. Resiliency system 110 and/or application 130 may process this streaming data in real-time to determine whether a resiliency mechanism should be deployed.

Resiliency system 110 may store prediction results in the cache. Resiliency system 110 and/or application 130 may use the prediction results to identify potential service degradation issues and/or determine proactive actions as further described herein. In some embodiments, resiliency system 110 may use an Apache Kafka® platform and/or cache for providing a notification to application 130. For example, a Kafka topic and/or cache may be used to analyze the prediction results and/or provide application system 130 with an indication of a resiliency mechanism to deploy. Kafka may also be used to pass a command from the resiliency system 110 to application 130.

In some embodiments, resiliency system 110 may determine a particular resiliency mechanism and instruct and/or command application 130 to perform a corresponding action. For example, failure prediction model 112 may determine the particular action to take. This may be selected via training of a machine learning model. For example, the training data may include one or more computational transaction metrics with corresponding resiliency mechanisms to execute when the metrics meet a particular detected condition. In some embodiments, resiliency system 110 may implement a rules-based and/or algorithmic determination based on results generated by failure prediction model 112. For example, resiliency system 110 may be preconfigured to execute one or more instructions in response to a detected result produced by failure prediction model 112. Resiliency system 110 may then provide a corresponding command and/or instruction to application 130.

In some embodiments, application 130 may determine the command and/or resiliency mechanism to deploy. For example, resiliency system 110 may determine and/or generate one or more predicted computational transaction metrics. Resiliency system 110 may then provide the one or more predicted computational transaction metrics to application 130. Application 130 may then determine and/or execute a resiliency mechanism based on the received prediction information from resiliency system 110.

To preemptively address an anticipate failure or service degradation from application 130, one or more resiliency mechanisms may be deployed. Such resiliency mechanisms may limit transaction access to application 130. For example, client devices 150 may be attempting to access application 130. Client device 150, however, may cause an increase in resource usage and/or an increase in transactions demanded per second. The access requests, transactions, executions, and/or other functionality performed by application 130 to service the client devices 150, however, may potentially result in application 130 becoming overwhelmed and/or failing. To avoid such a situation, the resiliency mechanisms may limit transaction access to application 130 and/or transaction executions.

In some embodiments, the resiliency mechanisms and/or response actions may include a circuit breaker action, a rate limiter action, a time limiter action, and/or a bulkhead action. The circuit breaker action may open or close a logic circuit to divert transactions from a failing or degraded application 130. For example, this may be implemented when an application 130 close to failure. For example, one or more computational transaction metrics and/or predicted computational transaction metrics may exceed a threshold corresponding to the circuit breaker action. In this case, application 130 may divert transaction requests away and/or not fulfill transaction requests. In some embodiments, application 130 may divert systems to a landing page. For example, a user using client device 150 to access application 130 may instead by diverted to a webpage providing alternative services. Similarly, a message may be displayed indicating that the application 130 is not available and/or an estimated amount of time before application 130 may become available again. In some embodiments, failure prediction model 112 and/or another machine learning model may predict an amount of time for application 130 to be restored to service. This amount of time may be displayed on the webpage.

The resiliency mechanisms may also include a rate limiter action. The rate limiter action may limit the traffic volume to a stressed system such as application 130. This may be a volume, amount, and/or a rate of transaction requests. For example, the rate limiter action may divert a percentage of transaction requests to application 130 while diverting another percentage away. This may be similar to the circuit breaker action. For example, the rate limiter action may instruct application 130 to accept and/or execute 50% of received transaction requests. This may be for a set amount of time and/or until a detection by failure prediction model 112 that application 130 is able to avoid the predicted failure state.

For example, the rate limiter action may instruct application 130 to accept and/or execute 50% of received transaction requests for 5 or 10 minutes. Load detection service 114 and/or failure prediction model 112 may monitor one or more computational transaction metrics during this time to determine a subsequent action. For example, failure prediction model 112 may determine that the load on application 130 is being reduced such that application 130 is capable of handling additional transaction requests. The rate limiter action may then be modified and/or increased to allow 75% of transactions to be directed to application 130. In some embodiments, failure prediction model 112 may determine that the load on application 130 is not being sufficiently reduced to avoid the failure state. In this case, the rate limiter action may then be modified and/or decreased to allow only 25% of transactions to be directed to application 130. In either case, load detection service 114 and/or failure prediction model 112 may continuously monitor the performance of application 130 to determine the particular course of action to take. This feedback mechanism may aid in allowing application 130 to quickly recover from and/or anticipate and address potential outages and/or service degradations. This may also provide a mechanism for some client devices 150 to receive service from application 130.

In some embodiments, the rate limiter action may be used together with the circuit breaker action to address a detected failure state. For example, the circuit breaker action may be used to limit all transaction requests to application 130. The rate limiter action may then incrementally divert a percentage of transactions to return to application 130. For example, 5% may be returned followed by 15%. Load detection service 114 and/or failure prediction model 112 may monitor metrics to ensure that the failure state is avoided.

Additionally, another resiliency mechanism is a time limiter action. The time limiter action may set timeout values for operations within a stressed system. For example, this may set an amount of time where application 130 does not accept transaction requests. This may be a 10 minute interval for example. The time limiter action may also be used when load detection service 114 and/or failure prediction model 112 detect one or more patterns during particular times of day. For example, if load detection service 114 and/or failure prediction model 112 determines that application 130 often enters a failure state between 8:00 PM and 9:00 PM every day, the time limiter action may instruct application 130 to limit the servicing of transactions during this time.

This time limiter action may also be used with the circuit breaker action and/or the rate limiter action. For example, a combined resiliency mechanism may be an instruction to perform a circuit breaker action for 5 minutes followed by a staggered rate limiter action over the next 20 minutes to restore service to application 130. Load detection service 114 and/or failure prediction model 112 may be trained to identify such a resiliency mechanism as well based on feedback. In this manner, load detection service 114 and/or failure prediction model 112 may determine one or more actions to take for application 130 to avoid a failure state and/or to restore service once the failure state has been avoided.

Another response action that may be taken is the bulkhead action. The bulkhead action may limit the number of concurrent transaction executions in a stressed system. For example, this may be a reflection of a workload for an application 130. This may account for a number of sub-tasks that application 130 is performing. The bulkhead action may limit this number of sub-tasks and/or actions. For example, a system implement application 130 may have the capability of handling 100 threads. A thread may refer to an execution of a sequence of programmed instructions. Threads may be managed independently by a scheduler, which may be part of an operating system. The system implementing application 130 may be enterprise data system 120. When load detection service 114 and/or failure prediction model 112 determines that the requested number of threads is approaching and/or exceeding this capacity, a bulkhead action may be used to reduce the system's workload. For example, the bulkhead action may include an instruction to limit execution to 25 or 40 threads for the next cycle of execution. In this manner, the bulkhead action may dynamically limit the number of concurrent executions in a stressed system.

The bulkhead action may also be used in combination with the circuit breaker, rate limiter, and/or time limiter actions as well. Similarly, load detection service 114 and/or failure prediction model 112 may monitor computational transaction metrics in response to one or more of these actions to determine additional adjustments. In this manner, the bulkhead action may also be used and/or modified based on feedback to allow application 130 to recover after avoiding a failure state.

In some embodiments, after executing a resiliency mechanism, resiliency system 110 may record the particular action taken, generate a report, and/or generate an alert to an administrator of application 130. This may provide a notification of a predicted failure state of application 130 and/or the one or more actions taken to avoid the failure state. The recorded information may also include the one or more computational transaction metrics used by resiliency system 110 to determine the action taken. This may provide model monitoring as well and/or may provide retrospective data explaining why a particular action was taken. This may also allow an administrator to update failure prediction model 112 if a particular action was undesirable. This may provide model re-training as well. While failure prediction model 112 may implement a time series algorithm, failure prediction model 112 may also be re-trained via supervised learning and/or labeled training data as well.

FIG. 1B depicts a block diagram of an application resiliency environment 100B with a resiliency system 110 external to an enterprise data system 120, according to some embodiments. Similar to FIG. 1A, application resiliency environment 100B includes resiliency system 110, enterprise data system 120, applications 130, enterprise database 140, and/or client devices 150. Resiliency system 110 further includes failure prediction model 112 and/or load detection service 114. Similar to FIG. 1A, resiliency system 110 may execute the methods and/or programming described with reference to FIG. 2 and/or FIG. 3. Resiliency system 110 may utilize these methods separately and/or in combination to detect potential failures that may occur in an application 130 and/or to activate a resiliency mechanism to avoid and/or to remediate service degradation. This operation may also occur in a manner similar to FIG. 1A.

In application resiliency environment 100B, resiliency system 110 may be a system that is external to an enterprise data system 120. For example, it may be provided as a plugin and/or a service accessed by enterprise data system 120. For example, resiliency system 110 may provide a service that is consumed by enterprise data system 120. Resiliency system 110 may also provide a plug and play architecture. Resiliency system 110 may be event driven and/or expandable.

In some embodiments, resiliency system 110 may also reside on a client device 150. In this configuration, resiliency system 110 may monitor one or more computational transaction metrics for enterprise data system 120 and/or the client device 150 where it resides. For example, resiliency system 110 may monitor application 130 metrics related to enterprise data system 120. Resiliency system 110 may then inform application 130 of any particular resiliency mechanisms to deploy similar to the description provided for FIG. 1A.

When executing on a client device, resiliency system 110 may monitor one or more computational transaction metrics related to the client device 150 as well. For example, resiliency system 110 may determine the CPU usage or memory usage of client device 150. Similarly, resiliency system 110 may track a workload and/or capability of client device 150 to execute transactions via communications with application 130. Resiliency system 110 may also provide a command and/or recommendation to client device 150 to perform a resiliency action as well if client device 150 is experience failures and/or service degradation.

Regardless of the location of resiliency system 110 as seen from FIG. 1A and FIG. 1B, resiliency system 110 may also aid in avoiding a cascading of failures when multiple applications 130 are working jointly to service a client device 150. This may occur when a particular application 130 depends on interactions and/or data from other applications 130. For example, application 130B may depend on and/or utilize data generated by and/or functions performed by application 130A. In this case, if application 130A experiences service degradation, this may also negatively impact application 130B. For example, there may be undesirable cascading failures because a failure at application 130A may result in a failure at application 130B. Resiliency system 110 may detect and/or mitigate such issues via one or more resiliency mechanisms. This may occur regardless of whether resiliency system 110 is a part of enterprise data system 120 as depicted in FIG. 1A and/or if resiliency system 110 is external to enterprise data system 120 as depicted in FIG. 1B.

FIG. 2 depicts a flowchart illustrating a method 200 for detecting a potential application failure and preemptively avoiding such a failure, according to some embodiments. Method 200 shall be described with reference to FIGS. 1A-1B; however, method 200 is not limited to that example embodiment.

In an embodiment, resiliency system 110 may utilize method 200 to detect a potential application failure and/or to transmit a command to prevent application 130 from entering a failure state. The foregoing description will describe an embodiment of the execution of method 200 with respect to resiliency system 110. While method 200 is described with reference to resiliency system 110, method 200 may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 2, as will be understood by a person of ordinary skill in the art.

At 205, resiliency system 110 trains a machine learning model to identify a potential application failure based on a set of computational transaction metrics. This may occur in a manner similar to FIG. 1A. For example, the training data may correlate failure state for one or more applications 130 based on one or more computation transaction metrics in the set. The machine learning model may be failure prediction model 112.

At 210, resiliency system 110 monitors one or more computational transaction metrics corresponding to an application 130. For example, load detection service 114 may monitor the computational transaction metrics as described with reference to FIG. 1A. In some embodiments, the one or more computation transaction metrics be the same as the set of computational transaction metrics used to train the machine learning model. In some embodiments, the one or more computation transaction metrics monitored by the resiliency system 110 may be a subset of the set of computational transaction metrics used to train the machine learning model.

At 215, resiliency system 110 detects a potential failure of the application 130 by applying the one or more computational transaction metrics to the machine learning model. For example, as described with reference to FIG. 1A, load detection service 114 may monitor the computational transaction metrics. These monitored metrics may be applied to the failure prediction model 112. For example, this may be time series data used to predict one or more future computational transaction metrics. Failure prediction model 112 may detect a pattern and/or an indication that application 130 may enter a failure state. This determination may be made in real-time. Upon detecting a potential failure, resiliency system 110 may provide a command and/or instruction to application 130 to deploy one or more resiliency mechanisms to avoid the failure state.

At 220, resiliency system 110 transmits a command to the application 130 to limit transaction access. As described with reference to FIG. 1A, this may include providing a command using a cache. Resiliency system 110 may deliver a message to application 130 via a distributed event store, cache, or platform. In some embodiments, resiliency system 110 may use a message broker and/or a middleware system to pass the message. This may be a high-throughput and/or low-latency platform that may manage real-time data feeds. This message delivery may also be performed even if application 130 is experiencing service degradation. In some embodiments, the notification may be stored and/or pushed to the application 130 via a cache storage. In some embodiments, the notification data may instruct the application to deploy one or more resiliency mechanisms as described with reference to FIG. 1A. This may include using one or more circuit breaker actions, rate limiter actions, time limiter actions, and/or bulkhead actions as previously described. Resiliency system 110 may also continuously monitor the computational transaction metrics to perform further adjustments to the resiliency mechanisms as previously described as well.

For example, resiliency system 110 may transmit a command that instructs application 130 to reject a portion of access requests received by the application 130 from one or more client devices 150. This may be a rate limiter action. Resiliency system 110 may transmit a command that instructs the application 130 to reject all access requests received by the application 130 from one or more client devices 150. This may be a circuit breaker action. Resiliency system 110 may transmit a command that instructs the application 130 to reject a portion of access requests received by the application 130 from one or more client devices 150 for an amount of time. This may be a time limiter action. Resiliency system 110 may transmit a command that instructs the application 130 to limit one or more concurrent transaction executions performed by the application 130. This may be a bulkhead action.

FIG. 3 depicts a flowchart illustrating a method 300 for activating a resiliency mechanism, according to some embodiments. Method 300 shall be described with reference to FIGS. 1A-1B; however, method 300 is not limited to that example embodiment.

In an embodiment, application 130 may utilize method 300 to activate a resiliency mechanism based on data stored in a cache. In some embodiments, resiliency system 110 and/or enterprise data system 120 may also perform method 300. The foregoing description will describe an embodiment of the execution of method 300 with respect to application 130 executing on enterprise data system 120. While method 300 is described with reference to application 130 executing on enterprise data system 120, method 300 may be executed on any computing device, such as, for example, the computer system described with reference to FIG. 4 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

At 305, application 130 periodically reads, from a cache, a prediction result generated by failure prediction model 112. Resiliency system 110 may have stored the prediction result in the cache as described with reference to FIG. 1A. For example, resiliency system 110 may transmit a command to the application 130 that may be predicted to experience the service degradation. Resiliency system 110 may deliver a message to application 130 via a distributed event store, cache, or platform. In some embodiments, resiliency system 110 may use a message broker and/or a middleware system to pass the message. This may be a high-throughput and/or low-latency platform that may manage real-time data feeds. This message delivery may also be performed even if application 130 is experiencing service degradation. The message may be an indication of the prediction result.

In some embodiments, the notification may be stored and/or pushed to the application 130 via a cache storage. This provide faster access by application 130 to the information. Resiliency system 110 and/or application 130 may process this streaming data in real-time to determine whether a resiliency mechanism should be deployed. Application 130 may periodically read the data in the cache. In some embodiments, the prediction result may be communicated as a command instructing the application 130 to perform an action. In some embodiments, the prediction result may be data corresponding to one or more predicted computational transaction metrics. Resiliency system 110 and/or application 130 may use the prediction results to identify potential service degradation issues and/or determine proactive actions as further described herein. In some embodiments, as described with reference to FIG. 1A, an Apache Kafka® platform and/or cache for providing a notification and/or data to application 130.

At 310, application 130 determines whether the prediction result exceeds a threshold. For example, application 130 may be configured to use the prediction data stored in the cache to determine a corresponding resiliency mechanism to deploy as described with reference to FIG. 1A. For example, this may include a metric such as transaction rate or transactions per second. If a predicted transaction rate exceeds a particular threshold value, application 130 may anticipate a failure may be imminent. For example, a threshold may be 200 transactions per second but a predicted value may indicate that a rate of 300 transactions per second may be imminent. In this case, application 130 may determine that the failure state may be imminent based on the predicted value exceeding the threshold.

In some embodiments, resiliency system 110 may also make this determination and/or provide instructions to application 130. For example, resiliency system 110 providing a notification to application 130 may indicate that the prediction result has exceeded the threshold. Resiliency system 110 may perform one or more threshold comparisons to determine whether the threshold has been exceeded.

At 315, if the prediction result does not exceed the threshold, application 130 may return to 305 to continue to periodically monitor data in the cache. For example, application 130 may resume operations without deploying a resiliency mechanism. If the prediction result exceeds the threshold, application 130 may proceed to 320. Resiliency system 110 and/or application 130 may perform the comparison and/or the determination that a resiliency mechanism is to be deployed.

At 320, application 130 may activate a resiliency mechanism to limit transaction access to the application 130. This may occur when application 130 determines that a failure state may be imminent based on a prediction result. Application 130 may make this determination and/or resiliency system 110 may provide a command to application 130 indicating one or more resiliency mechanisms to deploy.

Upon determining that one or more resiliency mechanisms is to be deployed, application 130 may perform a circuit breaker action 325, a rate limiter action 330, a time limiter action 335, and/or a bulkhead action 340. This may be performed as described with reference to FIG. 1A. For example, one or more resiliency mechanisms may be deployed to alleviate a stressed system and/or to provide aid to application 130. Resiliency system 110 may continue to monitor metrics related to application 130 to perform further adjustments to the deployed one or more resiliency mechanisms. Application 130 may continue to adjust the resiliency mechanisms using this feedback to avoid a failure state and/or to return to non-limited functionality once the threat of the failure has passed.

At 345, application 130 may record the action taken and generate an alert. In some embodiments, resiliency system 110 may also perform this action. Application 130 and/or resiliency system 110 may record the particular action taken, generate a report, and/or generate an alert to an administrator of application 130. This may provide a notification of a predicted failure state of application 130 and/or the one or more actions taken to avoid the failure state. The recorded information may also include the one or more computational transaction metrics used by resiliency system 110 to determine the action taken. This may provide model monitoring as well and/or may provide retrospective data explaining why a particular action was taken. This may also allow an administrator to update failure prediction model 112 if a particular action was undesirable. This may provide model re-training as well. While failure prediction model 112 may implement a time series algorithm, failure prediction model 112 may also be re-trained via supervised learning and/or labeled training data as well.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for predicting and avoiding potential application failures, comprising:
training a machine learning model to identify a potential application failure based on a set of computational transaction metrics;
monitoring one or more computational transaction metrics corresponding to an application executing on a server;
detecting a potential failure of the application by applying the one or more computational transaction metrics to the machine learning model; and
in response to the detecting, transmitting a command to the application to limit transaction access.

2. The computer implemented method of claim 1, wherein the command instructs the application to reject a portion of access requests received by the application from one or more client devices.

3. The computer implemented method of claim 1, wherein the command instructs the application to reject all access requests received by the application from one or more client devices.

4. The computer implemented method of claim 1, wherein the command instructs the application to reject a portion of access requests received by the application from one or more client devices for an amount of time.

5. The computer implemented method of claim 1, wherein the command instructs the application to limit one or more concurrent transaction executions performed by the application.

6. The computer implemented method of claim 1, wherein the one or more computational transaction metrics include a rate of infrastructure hardware usage.

7. The computer implemented method of claim 1, wherein the one or more computational transaction metrics include an application traffic trend.

8. A system, comprising:
a memory; and
at least one processor coupled to the memory and configured to:
train a machine learning model to identify a potential application failure based on a set of computational transaction metrics;
monitor one or more computational transaction metrics corresponding to an application executing on a server;
detect a potential failure of the application by applying the one or more computational transaction metrics to the machine learning model; and
in response to the detecting, transmit a command to the application to limit transaction access.

9. The system of claim 8, wherein the command instructs the application to reject a portion of access requests received by the application from one or more client devices.

10. The system of claim 8, wherein the command instructs the application to reject all access requests received by the application from one or more client devices.

11. The system of claim 8, wherein the command instructs the application to reject a portion of access requests received by the application from one or more client devices for an amount of time.

12. The system of claim 8, wherein the command instructs the application to limit one or more concurrent transaction executions performed by the application.

13. The system of claim 8, wherein the one or more computational transaction metrics include a rate of infrastructure hardware usage.

14. The system of claim 8, wherein the one or more computational transaction metrics include an application traffic trend.

15. A non-transitory computer-readable device having instructions stored thereon that, when executed by at least one computing device, cause the at least one computing device to perform operations comprising:
training a machine learning model to identify a potential application failure based on a set of computational transaction metrics;
monitoring one or more computational transaction metrics corresponding to an application executing on a server;
detecting a potential failure of the application by applying the one or more computational transaction metrics to the machine learning model; and
in response to the detecting, transmitting a command to the application to limit transaction access.

16. The non-transitory computer-readable device of claim 15, wherein the command instructs the application to reject a portion of access requests received by the application from one or more client devices.

17. The non-transitory computer-readable device of claim 15, wherein the command instructs the application to reject a portion of access requests received by the application from one or more client devices for an amount of time.

18. The non-transitory computer-readable device of claim 15, wherein the command instructs the application to limit one or more concurrent transaction executions performed by the application.

19. The non-transitory computer-readable device of claim 15, wherein the one or more computational transaction metrics include a rate of infrastructure hardware usage.

20. The non-transitory computer-readable device of claim 15, wherein the one or more computational transaction metrics include an application traffic trend.
